(19) United States
(12) Patent Application Publication
(10) Pub. No.: US 2011/0250511 A1
(43) Pub. Date: Oct. 13, 2011

(54) BIOFUEL CELL

(75) Inventors: Tsunetoshi Samukawa, Kanagawa (JP); Taiki Sugiyama, Kanagawa (JP); Shuji Fujita, Tokyo (JP); Yuichi Tokita, Kanagawa (JP); Hideki Sakai, Kanagawa (JP)

(73) Assignee: SONY CORPORATION, Tokyo (JP)

(21) Appl. No.: 13/078,552

(22) Filed: Apr. 1, 2011

(30) Foreign Application Priority Data
Apr. 8, 2010 (JP) P2010-089554

(51) Int. Cl. H01M 8/16

(52) U.S. Cl. 429/401

(57) ABSTRACT

Disclosed herein is a biofuel cell including a polymer gel reversibly swelling and contracting in response to variations in a property of a fuel solution making contact therewith, the polymer gel being on a surface of an electrode and/or in the inside of the electrode.

### BACKGROUND OF THE INVENTION

1. Field of the Invention

The present invention relates to a biofuel cell. More particularly, the invention relates to a biofuel cell which has a function to automatically restore a lowered output.

2. Description of the Related Art

In recent years, biofuel cells have been developed in which an oxidation-reduction enzyme is immobilized as a catalyst on at least one of an anode and a cathode. In biofuel cells, a high cell capacity can be obtained by efficiently taking out electrons from a fuel which is difficult to put into reaction by ordinary industrial catalysts, such as glucose and ethanol. In view of this, the biofuel cell is expected as a next-generation fuel cell that is high in capacity and safety.

For example, in a biofuel cell using glucose as a fuel, an oxidation reaction of glucose proceeds on an anode, and a reduction reaction of oxygen on a cathode, as shown in FIG. 4. At present, biofuel cells permitting use of various fuels, instead of being limited to the glucose-oxygen combination, are being under development.

In relation to the present invention, in recent years, there have been developed stimuli-responsive gels which show a volume phase transition together with a drastic change in physicochemical properties, such as hydrophilic/hydrophobic properties, in response to tiny variations in external environments such as solvent composition, pH, temperature, etc.

The stimuli-responsive gels which have been known include molecule-responsive gels showing a volume change through recognition of a specific molecule, and ion-responsive gels and temperature-responsive gels which are responsive to pH and temperature, respectively. The swelling behaviors of these stimuli-responsive gels are determined by (1) the affinity of the polymer constituting the gel for the solvent, (2) the state of charged groups in the polymer chains, (3) the number of crosslink points where the polymer chains are interconnected, and the like.

As the molecule-responsive gels, for instance, there have been developed those which swell/contract upon recognition of a specific molecule, by utilizing a molecular complex as a reversible crosslink point of the gel. Such molecule-responsive gels synthesized hitherto are classified into two types, namely, molecular crosslinked gel and molecular imprinted gel, based on the method of utilizing the molecular complex (see Japanese Patent Laid-open No. 2009-261334, Japanese Patent Laid-open No. 2007-244374, Japanese Patent Laid-open No. 2006-138656 and Republished PCT Patent Application 2002-090990).

The molecular crosslinked gel is a gel in which molecular complexes formed through preliminary interaction among molecules are bonded to the gel network. When the molecular crosslinked gel is exposed to the presence of a target molecule, the molecular complex bonded to the gel network is dissociated, whereby the number of the crosslink points is reduced, resulting in that the molecular crosslinked gel swells in response to the target molecules.

On the other hand, the molecular imprinted gel is a gel in which ligands capable of interaction with a target molecule are introduced in an optimum configuration. When the molecular imprinted gel is brought to the presence of a target molecule, a plurality of the ligands recognize one target molecule and form a complex with the target molecule, and such complexes serve as crosslink points, resulting in that the molecular imprinted gel contracts in response to the target molecules.

Besides, examples of the ion-responsive gels include gels which have an ionic functional group such as groups of carboxylic acid, phosphoric acid, sulfonic acid, primary amine, secondary amine, tertiary amine, quaternary ammonium, etc. in the molecule thereof (see Japanese Patent Laid-open No. 2006-352947). The ion-responsive gel swells and contracts through changes in the affinity of the polymer for the solvent or in the state of charged groups in the polymer chains depending on ion concentration (ionic strength).

Further, the temperature-responsive gels are obtained by crosslinking a polymer compound which in a solution state is in a uniformly dissolved state equal to or below a certain temperature but which undergoes phase separation into two phases different in composition equal to or above the certain temperature. The temperature-responsive gel swells equal to or below a phase transition temperature, and, equal to or above the phase transition temperature, it releases a medium and shows a rapid contraction in volume. In recent years, a biodegradable temperature-responsive polymer of a block polymer type composed of polylactic acid and polyethylene glycol has also been developed (see “Biodegradable block copolymers as injectable drug-delivery systems,” Nature, 388, pp. 860-862, 1997).

### SUMMARY OF THE INVENTION

In the biofuel cells, ordinarily, there is adopted a passive system in which the supply of the fuel such as glucose and oxygen and the like to the electrodes are dependent on spontaneous diffusion of the fuel in the fuel solution. This is because the biofuel cells according to the related art are low in cell output and, therefore, it is difficult to incorporate into the cell a pump or the like for efficiently supplying a fuel to the electrode.

In the biofuel cells of the passive system in which the supply of the fuel to the electrode depends on spontaneous diffusion of the fuel, there has been a problem that, attendant on the progress of the oxidation-reduction reaction of the fuel, the fuel concentration in the vicinity of an electrode would become lower than that in the areas remote from the electrode, generating a gradient of fuel concentration in the fuel solution. Besides, as the oxidation-reduction reaction on an electrode in the biofuel cells of the passive system proceeds, pH gradient would be generated between the vicinity of the electrode and the areas remote from the electrode or a change in the temperature in the vicinity of the electrode would be generated.

In the biofuel cells according to the related art, therefore, with the lapse of time, the quantity of the fuel supplied to an electrode may be reduced or pH and/or temperature in the vicinity of an electrode may be partially varied, possibly leading to a lowering in the efficiency of the oxidation-reduction reaction of the fuel or to a lowering in cell output. In addition, the biofuel cells of the passive system have been low in final fuel utilization efficiency (energy efficiency).

Thus, there is a need for a biofuel cell having a function to automatically recover from a lowering in cell output due to any of fuel concentration gradient and pH gradient in a fuel solution and variations in temperature in the vicinity of an electrode which are generated attendant on the progress of an oxidation-reduction reaction of the fuel.

According to an embodiment of the present invention, there is provided a biofuel cell including a polymer gel reversibly swelling and contracting in response to variations in a property of a fuel solution making contact therewith, the polymer gel being on a surface of an electrode and/or in the inside of the electrode.

In the biofuel cell as above, the polymer gel swells and contracts in response to variations in a property of the fuel solution making contact therewith, whereby the diffusibility of the fuel solution or of a substance in the solution can be enhanced and/or the fuel solution can be stirred.

In the biofuel cell according to the embodiment, preferably, the electrode has a porous material, and the polymer gel is present in pores of the electrode; particularly, it is preferable that the electrode has a laminate of carbon fibers, and the polymer gel is present in gaps between the carbon fibers.

Where the electrode has a laminate of carbon fibers and the polymer gel is disposed in gaps between the carbon fibers, the polymer gel which swells and contracts in response to variations in a property of the fuel solution making contact therewith causes the electrode itself also to swell and contract, whereby the diffusibility of the fuel solution or of a substance in the solution can be enhanced and/or the fuel solution can be agitated.

In the biofuel cell according to the embodiment, the variations in the property may be variations in at least one selected from the group consisting of fuel concentration, ion concentration and temperature of the fuel solution; and the polymer gel may be an appropriate combination of at least one selected from the group consisting of a molecule-responsive gel, an ion-responsive gel, and a temperature-responsive gel. Specifically, the polymer gel may be at least one selected from the group consisting of a molecule-responsive gel which swells in the presence of a fuel and contracts in the absence of the fuel, a proton-responsive gel which swells under a high-pH condition and contracts under a low-pH condition, and a temperature-responsive gel which contracts under a high-temperature condition and swells under a low-temperature condition. Or, alternatively, the polymer gel may be at least one selected from the group consisting of a molecule-responsive gel which contracts in the presence of a fuel and swells in the absence of the fuel, a proton-responsive gel which contracts under a high-pH condition and swells under a low-pH condition, and a temperature-responsive gel which swells under a high-temperature condition and contracts under a low-temperature condition.

According to the embodiment of the present invention as above, it is possible to provide a biofuel cell having a function to automatically recover from a lowering in cell output due to any of fuel concentration gradient and pH gradient in a fuel solution and variations in temperature in the vicinity of an electrode which are generated attendant on the progress of an oxidation-reduction reaction of the fuel.

### BRIEF DESCRIPTION OF THE DRAWINGS

FIG. 1 illustrates the configuration of a biofuel cell according to a first embodiment of the present invention, and swelling/contraction behaviors of a polymer gel disposed in the biofuel cell;

FIG. 2 illustrates the configuration of a biofuel cell according to a second embodiment of the present invention, and swelling/contraction behaviors of a polymer gel disposed in the biofuel cell;

FIG. 3 illustrates the configuration of a biofuel cell according to a third embodiment of the present invention, and swelling/contraction behaviors of a polymer gel disposed in the biofuel cell; and

FIG. 4 illustrates oxidation-reduction reactions on electrodes in a biofuel cell in which glucose is used as a fuel.

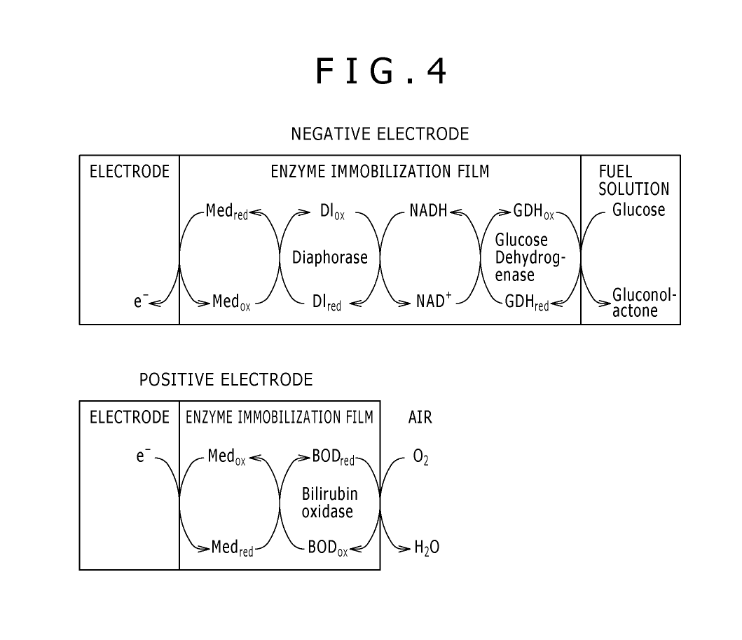

### DETAILED DESCRIPTION OF THE PREFERRED EMBODIMENTS

Now, preferred embodiments of the present invention will be described below. The following embodiments are merely examples of representative embodiments of the present invention, and the invention is not to be narrowly interpreted thereby. The description will be carried out in the following order.

### 1. First Embodiment

[Fuel Solution]

[Electrodes]

[Current Collectors]

[Protonic Conductor]

[Anode Enzymes]

[Cathode Enzymes]

[Polymer Gel]

[Swelling/Contraction Behaviors of Polymer Gel]

### 2. Second Embodiment

[Fuel Solution, Current Collectors, Protonic Conductor, and Enzymes]

[Electrodes]

[Polymer Gel]

[Swelling/Contraction Behaviors of Polymer Gel]

### 3. Third Embodiment

[Fuel Solution, Current Collectors, Protonic Conductor, and Enzymes]

[Electrodes]

[Polymer Gel]

[Swelling/Contraction Behaviors of Polymer Gel]

### 1. First Embodiment

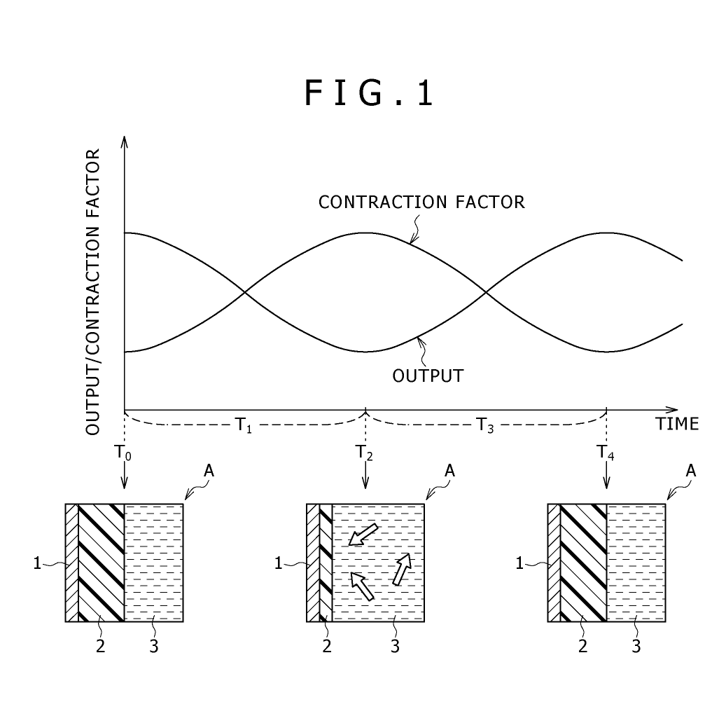

FIG. 1 illustrates the configuration of a biofuel cell according to a first embodiment of the present invention, and swelling/contraction behaviors of a polymer gel disposed in the biofuel cell. At the top of the figure is a graph showing time variations of output of a biofuel cell and contraction ratio of a polymer gel. At the bottom of the figure are schematic illustrations showing the configuration of the vicinity of an electrode in the biofuel cell and the swelling/contraction behaviors of the polymer gel.

The biofuel cell denoted by symbol A in the drawing includes an electrode 1, a polymer gel 2 disposed on a surface of the electrode 1, and a fuel solution 3 for supplying the electrode 1 with a fuel. In the biofuel cell A, the fuel in the fuel solution 3 is supplied to the electrode 1 through the polymer gel 2.

[Fuel Solution]

The fuel solution 3, preferably, is a liquid containing at least one substance which can be used as a fuel in the biofuel cell and which can serve as a substrate for an oxidation-reduction enzyme on the electrode 1.

Examples of the substance which can be used as the fuel include saccharides, alcohols, aldehydes, lipids and proteins. Specific examples include saccharides such as glucose, fructose, sorbose, etc., alcohols such as methanol, ethanol, propanol, glycerin, polyvinyl alcohol, etc., aldehydes such as formaldehyde, acetaldehyde, etc., and organic acids such as acetic acid, formic acid, pyruvic acid, etc. Other examples than the just-mentioned include oils and fats, proteins, and organic acids as intermediate products of saccharometabolism of these substances.

[Electrodes]

The electrodes 1 include a fuel electrode (negative electrode) at which electrons are taken out through an oxidation reaction of the above-mentioned substance and an air electrode (positive electrode) at which to carry out a reduction reaction of oxygen supplied externally.

The materials for the negative electrode (anode) and the positive electrode (cathode) are not particularly limited insofar as they are materials which can be electrically connected to external members. Examples of the materials which can be used here includes metals such as Pt, Ag, Au, Ru, Rh, Os, Nb, Mo, In, Ir, Zn, Mn, Fe, Co, Ti, V, Cr, Pd, Re, Ta, W, Zr, Ge, Hf, etc., alloys such as alumel, brass, duralumin, bronze, Nickelin, platinum-rhodium alloy, Hiperco, permalloy, Permendur, German silver, phosphor bronze, etc., conductive polymers such as polyacetylene, etc., carbon materials such as graphite, carbon black, etc., borides such as HfB₂, NbB, CrB₂, B₄C, etc., nitrides such as TiN, ZrN, etc., silicides such as VSi₂, NbSi₂, MoSi₂, TaSi₂, etc., and composite materials of them.

[Current Collectors]

An anode current collector and a cathode current collector which are formed from materials similar to those of the electrodes 1 and by which electrons released at the anode are sent to the cathode through an external circuit are connected respectively to the anode and the cathode (not shown in the drawing).

[Protonic Conductor]

The anode and the cathode are arranged with a protonic conductor therebetween (not shown in the drawing). The material to be used as the protonic conductor is not particularly limited, insofar as it is an electrolyte which does not have electronic conductivity and which can transport H. Any of the known materials which satisfy these conditions can be selected for use here.

As the protonic conductor, for example, an electrolyte containing a buffer substance can be used. Examples of the buffer substance include dihydrogen phosphate ion (H₂PO₄⁻) produced by sodium dihydrogen phosphate (NaH₂PO₄) or potassium dihydrogen phosphate (KH₂PO₄) or the like, 2-amino-2-hydroxymethyl-1,3-propanediol (abbreviated to tris), 2-(N-morpholino)ethanesulfonic acid (MES), cacodylic acid, carbonic acid (H₂CO₃), hydrogen citrate ion, N-(2-acetamido)iminodiacetic acid (ADA), piperazine-N,N′-bis(2-ethanesulfonic acid) (PIPES), N-(2-acetamido)-2-aminoethanesulfonic acid (ACES), 3-(N-morpholino)propanesulfonic acid (MOPS), N-2-hydroxyethylpiperazine-N′-2-ethanesulfonic acid (HEPES), N-2-hydroxyethylpiperazine-N′-3-propanesulfonic acid (HEPPS), N-[tris(hydroxymethyl)methyl]glycine (abbreviated to tricine), glycylglycine, N,N-bis(2-hydroxyethyl)glycine (abbreviated to bicine), imidazole, triazole, pyridine derivatives, bipyridine derivatives, and compounds having an imidazole ring such as imidazole derivatives (histidine, 1-methylimidazole, 2-methylimidazole, 4-methylimidazole, 2-ethylimidazole, imidazole-2-carboxylic acid ethyl, imidazole-2-carboxylaldehyde, imidazole-4-carboxylic acid, imidazole-4,5-dicarboxylic acid, imidazol-1-yl-acetic acid, 2-acetylbenzimidazole, 1-acetylmidazole, N-acetylimidazole, 2-aminobenzimidazole, N-(3-aminopropyl)imidazole, 5-amino-2-(trifluoromethyl)benzimidazole, 4-azabenzimidazole, 4-aza-2-mercaptobenzimidazole, benzimidazole, 1-benzylimidazole, 1-butylimidazole). Also usable are Nafions, which are solid electrolytes, and the like.

[Anode Enzymes]

An oxidase on the anode of the electrodes 1 is an enzyme which catalyzes the oxidation reaction of the above-mentioned substance so as to take out electrons.

Examples of such an enzyme include glucose dehydrogenase, gluconate-5-dehydrogenase, gluconate-2-dehidrogenase, alcohol dehydrogenases, aldehyde reductases, aldehyde dehydrogenases, lactate dehydrogenase, hydroxypyruvate dehydrogenase, glycerate dehydrogenase, formate dehydrogenase, fructose dehydrogenase, galactose dehydrogenase, malate dehydrogenase, glyceraldehyde-3-phosphate dehydrogenase, lactate dehydrogenase, sucrose dehydrogenase, fructose dehydrogenase, sorbose dehydrogenase, pyruvate dehydrogenase, isocitrate dehydrogenase, 2-oxoglutarate dehydrogenase, succinate dehydrogenase, malate dehydrogenase, acyl-CoA dehydrogenase, L-3-hydroxyacyl-CoA dehydrogenase, 3-hydroxypropionate dehydrogenase, 3-hydroxybutyrate dehydrogenase, etc.

Besides, an oxidized coenzyme and a coenzyme oxidase may be immobilized on the anode, in addition to the above-mentioned oxidase. Examples of the oxidized coenzyme include nicotinamideadenine dinucleotide (hereinafter expressed as “NAD+”), nicotinamideadenine dinucleotide phosphate (hereinafter expressed as “NADP+”), flavin adenine dinucleotide (hereinafter expressed as “FAD+”), and pyrrollo-quinoline quinone (hereinafter expressed as “PQQ2+”). Examples of the coenzyme oxidase include diaphorase.

Further, an electron transport mediator may be immobilized on the anode, in addition to the above-mentioned oxidase and the oxidized coenzyme. This is for ensuring smoother transfer of the generated electrons to the electrode. A variety of materials can be used as the electron transport mediator. Preferably, a compound having a quinone skeleton or a compound having a ferrocene skeleton is used. The compound having the quinone skeleton is preferably a compound which has a naphthoquinone skeleton or an anthraquinone skeleton. Further, together with the compound having the quinone skeleton or the compound having the ferrocene skeleton, one or more other compounds capable of functioning as an electron transport mediator may be immobilized on the anode.

Specific examples of the usable compounds having the naphthoquinone skeleton include 2-amino-1,4-naphthoquinone (ANQ), 2-amino-3-methyl-1,4-naphthoquinone (AMNQ), 2-amino-3-carboxy-1,4-naphthoquinone (ACNQ), 2,3-diamino-1,4-naphthoquinone, 4-amino-1,2-naphthoquinone, 2-hydroxy-1,4-naphthoquinone, 2-methyl-3-hydroxy-1,4-naphthoquinone, vitamin K₁ (2-methyl-3-phytyl-1,4-naphthoquinone), vitamin K₂ (2-farnesyl-3-methyl-1,4-naphthoquinone), and vitamin K₃ (2-methyl-1,4-naphthoquinone). In addition, as the compound having the quinone skeleton, for example, compounds having an anthraquinone skeleton such as anthraquinone-l-sulfonate, anthraquinone-2-sulfonate, etc. and their derivatives can also be used. As the compound having the ferrocene skeleton, for example, vinylferrocene, dimethylaminomethylferrocene, 1,1′-bis(diphenylphosphino)ferrocene, dimethylferrocene, ferrocenemonocarboxylic acid, and the like can be used. Further, other compounds which can be used include metal complexes of ruthenium (Ru), cobalt (Co), manganese (Mn), molybdenum (Mo), chromium (Cr), osmium (Os), iron (Fe), or the like; viologen compounds such as benzylviologen; compounds having a nicotinamide structure; compounds having a riboflavin structure; and compounds having a nucleotide phosphate structure. More specific examples include cis-[Ru(NH₃)₄C₁₂]^{1+/0}, trans-[Ru(NH₃)₄C₁₂]^{1+/0}, [Co(dien)₂]^{3+/2+}, [Mn(CN)₆]^{3-/4-}, [Mn(CN)₆]^{4-/5-}, [Mo₂O₃S(edta)]^{2-/3-}, [Mo₂O₂S₂(edta)]^{2-/3-}, [Mo₂O₄(edta)]^{2-/3-}, [Cr(edta)(H₂0)]^{1-/2-}, [Cr(CN)₆]^{3-/4-}, methylene blue, pycocyanine, indigo-tetrasulfonate, luciferin, gallocyanine, pyocyanine, methyl apri blue, resorufin, indigo-trisulfonate, 6,8,9-trimethyl-isoalloxazine, chloraphine, indigo disulfonate, nile blue, indigocarmine, 9-phenyl-isoalloxazine, thioglycolic acid, 2-amino-N-methyl phenazinemethosulfate, azure A, indigo-monosulfonate, anthraquinone-1,5-disulfonate, alloxazine, brilliant alizarin blue, crystal violet, patent blue, 9-methyl-isoalloxazine, cibachron blue, phenol red, anthraquinone-2,6-disulfonate, neutral blue, bromphenol blue, anthraquinone-2,7-disulfonate, quinoline yellow, riboflavin, flavin mononucleotide (FMN), flavin adenine dinucleotide (FAD), phenosafranin, lipoamide, safranine T, lipoic acid, indulin scarlet, 4-aminoacridine, acridine, nicotinamideadenine dinucleotide (NAD), nicotinamide adenine dinucleotidephosphate (NADP), neutral red, cysteine, benzyl viologen(2+/1+), 3-aminoacridine, 1-aminoacridine, methyl viologen(2+/1+), 2-aminoacridine, 2,8-diaminoacridine, and 5-aminoacridine. In the above chemical formulas, dien stands for diethylenetriamine, and edta stands for ethylenediaminetetraacetate tetraanione.

[Cathode Enzymes]

The enzyme on the cathode of the electrodes 1 is an enzyme which catalyzes the reduction reaction of oxygen supplied externally.

Such an enzyme is an enzyme which has oxidase activity with oxygen as a reaction substrate. Examples of such an enzyme include laccase, bilirubin oxidase, ascorbate oxidase, CueO, and CotA.

Besides, an electron transport mediator may be immobilized on the cathode, in addition to the just-mentioned enzyme. This is for ensuring smoother transfer of the electrons sent from the anode. The electron transport mediator which can be immobilized on the cathode is required only to be higher in oxidation-reduction potential than the electron transport mediator used for the anode. Electron transport mediators which satisfy this condition can be freely selected for use, as required.

Specific examples of the electron transport mediator to be used here include ABTS (2,2′-azinobis(3-ethylbenzoline-6-sulfonate)) , K₃[Fe(CN)₆], RuO₄^{0/1-}, [Os(trpy)₃]^{3+/2+}, [Rh(CN)₆]^{3-/4--}, [Os(trpy)(dpy)(py)]^{3+/2+}, IrCl₆^{2-/3-}, [Ru(CN)₆]^{3-/4-}, OsCl₆^{2-/3-}, [Os(py)₂(dpy)₂]^{3+/2+}, [Os(dpy)₃]^{3+/2+}, Cu^{III/II}(H₂A₃)^{0/1-}, [Os(dpy)(py)₄]^{3+/2+}, IrBr₆^{2-/3-}, [Os(trpy)(py)₃]^{3+/2+}, [Mo(CN)₈]^{3-/4-}, [Fe(dpy)]^{3+/2+}, [Mo(CN)₈]^{3-/4-}, Cu^{III/II}(H₂G₃a)^{0/1-}, [Os(4,4′-Me₂-dpy)₃]^{3+/2+}, [Os(CN)₆]^{3-/4-}, RuO₄^{1-/2-}, [Co(ox)₃]^{3-/4-}, [Os(trpy)(dpy)Cl]^{2+/1+}, I₃⁻/I⁻, [W(CN)₈]^{3-/4-}, [Os(2-Me-Im)₂(dpy)₂]^{3+/2+}, ferrocene carboxylic acid, [Os(Im)₂(dpy)₂]^{3+/2+}, [Os(4-Me-Im)₂(dpy)₂]^{3+/2+}, OsBr₆^{2-/3-}, [Fe(CN)₆]^{3-/4-}, ferrocene ethanol, [Os(Im)₂(4,4′-Me₂-dpy)₂]^{3+/2+}, [Co(edta)]^{1-/2-}, [Co(pdta)]^{1-/2-}, [Co(cydta)]^{1-/2-}, [Co(phen)_{3+/2+}, [OsCl(1-Me-Im)(dpy)₂]^{3+/2+}, [OsCl(Im)(dpy)₂]^{3+/2+}, [Co(5-Me-phen)₃]^{3+/2+}, [Co(trdta)]^{1-/2-}, [Ru(NH₃)₅(py)]^{3+/2+}, [Co(dpy)₃]^{2+/3+}, [Ru(NH₃)₅(4-thmpy)]^{3+/2+}, Fe^{3+/2+} malonate, Fe^{3+/2+} salycylate, [Ru(NH₃)₅(4-Me-py)]^{3+/2+}, [Co(trpy)₂]^{3+/2+}, [Co(4-Me-phen)₃]^{3+/2+}, [Co(5-NH₂-phen)₃]^{3+/2+}, [Co(4,7-(bhm)₂phen)]^{3+/2+}, [Co(5,6-Me₄-phen)₃]^{3+/2+}, trans (N)-[Co(gly)₃]^{0/1-}, [OsCl(1-Me-Im)(4,4′-Me₂-dpy)₂]^{3+/2+}, [OsCl(Im)(4,4′-Me₂-dpy)₂]^{3+/2+}, [Fe(edta)]^{1-/2-}, [Co(4,7-Me₂-phen)₃]^{3+/2+}, [Co(4,7-Me₂-phen)₃]^{3+/2+}, [Co(3,4,7,8-Me₄-phen)₃]^{3+/2+}, [Co(NH₃)₆]^{3+/2+}, [Ru(NH₃)₆]^{3+/2+}, [Fe(ox)₃]^{3-/4-}, promazine (n=1)[ammonium form], chloramine-T, TMPDA (N,N,N′,N′-tetramethylphenylenediamine), porphyrexide, syringaldazine, o-tolidine, bacteriochlorophyll a, dopamine, 2,5-dihydorxy-1,4-benzoquinone, p-amino-dimethylaniline, o-quinone/1,2-hydroxybenzene (catechol), p-aminophenoltetrahydroxy-p-benzoquinone, 2,5-dichloro-p-benzoquinone, 1,4-benzoquinone, diaminodurene, 2,5-dihydorxyphenylacetic acid, 2,6,2′-trichloroindophenol, indophenol, o-toluidine blue, DCPIP (2,6-dichlorophenolindophenol), 2,6-dibromo-indophenol, phenol blue, 3-amino-thiazine, 1,2-naphthoquinone-4-sulfonate, 2,6-dimethyl-p-benzoquinone, 2,6-dibromo-2′-methoxy-indophenol, 2,3-dimethoxy-5-methyl-1,4-benzoquinone, 2,5-dimethyl-p-benzoquinone, 1,4-dihydroxy-naphthoic acid, 2,6-dimethyl-indophenol, 5-isopropyl-2-methyl-p-benzoquinone, 1,2-naphthoquinone, 1-naphthol-2-sulfonate indophenol, toluylene blue, TTQ (tryptophan tryptophylquinone) model (3-methyl-4-(3′-methylindol-2′-yl)indol-6,7-dione), ubiquinone (coenzyme Q), PMS (N-methylphenazinium methosulfate), TPQ (topa quinone or 6-hydroxydopa quinone), PQQ (pyrroloquinolinequinone), thionine, thionine-tetrasulfonate, ascorbic acid, PES (phenazineethosulfate), cresyl blue, 1,4-naphthoquinone, toluidine blue, thiazine blue, gallocyanine, thioindigo disulfonate, methylene blue, and vitamin K₃ (2-methyl-1,4-naphthoquinone. In the above chemical formulas, dpy stands for 2,2′-dipyridine, phen stands for 1,10-phenanthroline, Tris stands for tris(hydroxymethyl)aminomethane, trpy stands for 2,2′:6′,2″-terpyridine, Im stands for imidazole, py stands for pyridine, thmpy stands for 4-(tris(hydroxymethyl)methyl)pyridine, bhm stands for bis(hydroxymethyl)methyl, G3a stands for triglycineamide, A3 stands for trialanine, ox stands for oxalate dianione, edta stands for ethylenediaminetetraacetate tetraanione, gly stands for glycinate anion, pdta stands for propylenediaminetetraacetate tetraanione, trdta stands for trimethylenediaminetetraacetate tetraanione, and cydta stands for 1,2-cyclohexanediaminetetraacetate tetraanione.

The immobilization of the enzyme, the coenzyme and the electron transport mediator onto the electrodes 1 can be carried out by a known method. Examples of the method include a method in which an immobilizing support using glutaraldehyde and poly-L-lysine as a crosslinking agent is used, and a method in which a polymer having protonic conductivity such as acrylamide is used.

[Polymer Gel]

The polymer gel 2 is a gel which reversibly swells and contracts in response to variations in a property of the fuel solution making contact therewith. In this embodiment, the case where a molecule-responsive gel which swells and contracts in response to fuel concentration of a fuel solution, specifically, a molecule-responsive gel which swells in the presence of a fuel and contracts in the absence of the fuel is used as the polymer gel 2 will be described as an example.

The polymer gel 2 may be a gel which is a molecular crosslinked gel in which molecular complexes formed through preliminary interaction among molecules are bonded to the gel network and which, in the presence of fuel molecules, swells because the number of crosslink points therein is reduced through dissociation of the molecular complexes bonded to the gel network.

For example, in the case where glucose is used as the fuel, poly(GEMA)-Con.A copolymer gel can be used as the above-mentioned polymer gel 2. The poly(GEMA)-Con.A copolymer gel is obtained by forming a complex from glucosylethyl methacrylate (GEMA), which is a monomer having glucose in side chains, and lectin (Concanavalin A (Con.A)), which is a sugar-binding protein, followed by copolymerization using a crosslinking agent (N,N′-methylenebisacrylamide (MBAA)).

[Swelling/Contraction Behaviors of Polymer Gel]

After power generation by the biofuel cell A is started, the oxidation-reduction reaction of the fuel proceeds at an enzyme immobilization film of the electrode 1, whereby the fuel in the fuel solution is consumed. Therefore, the fuel concentration of the fuel solution 3 in the vicinity of the electrode 1 is lowered with the lapse of time. Attendant on this, the concentration of the fuel in the fuel solution 3 becomes lower in the vicinity of the electrode 1 than that in the areas remote from the electrode 1, resulting in a gradient of fuel concentration in the fuel solution 3. Accordingly, the quantity of the fuel supplied to the electrode 1 by spontaneous diffusion is reduced, and the oxidation-reduction reaction of the fuel at the enzyme immobilization film on the electrode 1 is suppressed, so that the output of the biofuel cell A starts being lowered (see time T₁, in the figure).

On the other hand, when the fuel concentration of the fuel solution 3 in the vicinity of the electrode 1 is lowered due to the progress of the oxidation-reduction reaction of the fuel at the enzyme immobilization film of the electrode 1, the fuel concentration of the fuel solution 3 making contact with the polymer gel 2 is also lowered. In this instance, the polymer gel 2 contracts in response to the lowering in the fuel concentration of the fuel solution 3 (see time T₂).

As shown at the bottom of the drawing, the contraction of the polymer gel 2 increases the volume for containing the fuel solution 3, thereby enhancing the diffusibility of the fuel solution 3 and of the fuel in the solution (see block arrows, in the drawing). In addition, by changing the volume for containing the fuel solution 3, the polymer gel 2 stirs the fuel solution 3. As a result of these processes, the fuel concentration gradient generated in the fuel solution 3 is eliminated, and the quantity of the fuel supplied to the electrode 1 by spontaneous diffusion is increased. Consequently, the oxidation-reduction reaction of the fuel at the enzyme immobilization film on the electrode 1 is increased, so that the output of the biofuel cell A having started being lowered is restored (see time T₃).

As the fuel concentration of the fuel solution 3 in the vicinity of the electrode 1 rises due to the elimination of the fuel concentration gradient generated in the fuel solution 3, the fuel concentration of the fuel solution 3 making contact with the polymer gel 2 rises, too. In this instance, the polymer gel 2 swells in response to the rise in the fuel concentration of the fuel solution 3 (see time T₄). This swelling of the polymer gel 2 also shows a stirring effect on the fuel solution 3.

When the quantity of the fuel supplied to the electrode 1 is increased and the oxidation-reduction reaction of the fuel at the enzyme immobilization film on the electrode 1 is increased, power generation at a high output is performed until a fuel concentration gradient is again generated in the fuel solution 3. Thereafter, when the output starts being lowered again due to generation of a fuel concentration gradient in the fuel solution 3 attendant on the progress of the oxidation-reduction reaction, contraction of the polymer gel 2 occurs and recovery of the output is achieved through the above-mentioned mechanism.

As above-mentioned, in the biofuel cell A, when the quantity of the fuel supplied to the electrode 1 is reduced and the output starts being thereby lowered due to the generation of the fuel concentration gradient in the fuel solution 3 attendant on the progress of the oxidation-reduction reaction of the fuel, the polymer gel 2 contracts so as to enhance the diffusibility of the fuel solution 3 and of the fuel in the solution and to increase the quantity of the fuel supplied to the electrode 1, thereby automatically restoring the output. In the biofuel cell A, therefore, the problem of a lowering in output experienced in the passive-type biofuel cells according to the related art can be solved, and a high output can be maintained.

In the present embodiment, the case where a molecule-responsive gel which swells and contracts in response to fuel concentration of a fuel solution, specifically, a molecule-responsive gel which swells in the presence of a fuel and contracts in the absence of the fuel is used as the polymer gel 2 has been described as an example. However, the polymer gel 2 to be used may be a molecule-responsive gel which contracts in the presence of a fuel and swells in the absence of the fuel, contrary to the above. In this case, also, the polymer gel 2 repeats swelling and contraction in response to variations in the fuel concentration in the vicinity of the electrode 1, whereby stirring of the fuel solution 3 can be achieved. Consequently, the fuel concentration gradient generated in the fuel solution 3 attendant on the progress of the oxidation-reduction reaction can be eliminated, and the quantity of the fuel supplied to the electrode 1 through spontaneous diffusion can be thereby increased, so that the output can be recovered.

### 2. Second Embodiment

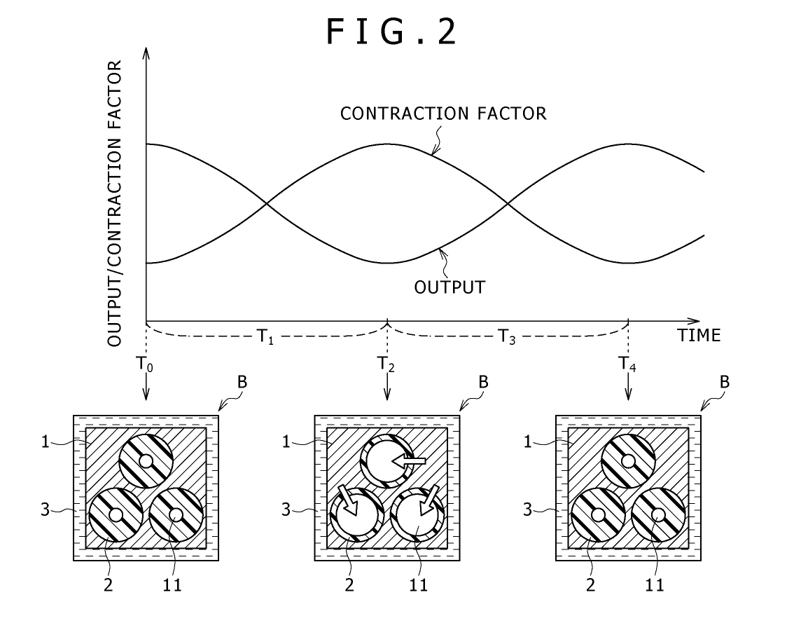

FIG. 2 illustrates the configuration of a biofuel cell according to a second embodiment of the present invention and swelling/contraction behaviors of a polymer gel disposed in the biofuel cell. At the top of the figure is a graph showing time variations in output of the biofuel cell and in contraction factor of the polymer gel. At the bottom of the drawing are schematic illustrations showing the configuration of the vicinity of an electrode in the biofuel cell and the swelling/contraction behaviors of the polymer gel.

The biofuel cell denoted by symbol B in the drawing includes an electrode 1 having a porous material, a polymer gel 2 disposed in the inside (pores) of the electrode 1, and a fuel solution 3 for supplying the electrode 1 with a fuel.

[Fuel Solution, Current Collectors, Protonic Conductor, and Enzymes]

The fuel solution 3, current collectors, a protonic conductor, enzymes and the like in the biofuel cell B may be the same in configuration as those in the biofuel cell A described in the first embodiment above.

[Electrodes]

The electrode 1 is formed from a material which can be electrically connected to an external member, like in the biofuel cell A; particularly, the electrode 1 is formed from a porous material such as carbon fiber, porous carbon, carbon pellet, carbon felt, carbon paper, etc. In the drawing, symbol 11 denotes the pore in the electrode 1 formed from the porous material. The polymer gel 2 is disposed on surfaces of the pores 11, and a fuel in the fuel solution 3 is supplied to the electrode 1 through the polymer gel 2.

[Polymer Gel]

The polymer gel 2 reversibly swells and contracts in response to variations in a property of the fuel solution making contact therewith. In this embodiment, the case where an ion-responsive gel which swells and contracts in response to ion concentration (proton ion concentration) of the fuel solution, specifically, a proton-responsive gel which swells in a high-pH condition and contracts in a low-pH condition is used as the polymer gel 2 will be described as an example.

The polymer gel 2 may be a gel which swells and contracts owing to changes in the affinity of the polymer for a solvent or in the state of charged groups in the polymer chains, dependently on the ion concentration (ionic strength).

As such a polymer gel 2, there can be used a gel which has an ionic functional group of carboxylic acid, phosphoric acid, sulfonic acid, primary amine, secondary amine, tertiary amine, quaternary ammonium or the like in the molecule thereof.

Specific examples of the polymer gel material include polymers of acrylic acid, methacrylic acid, vinyl acetate, maleic acid, methacryloyloxyethylphosphoric acid, vinylsulfonic acid, styrenesulfonic acid, vinylpyridine, vinylaniline, vinylimidazole, aminoethyl acrylate, methylaminoethyl acrylate, dimethylaminoethyl acrylate, ethylaminoethyl acrylate, ethylmethylaminoethyl acrylate, diethylaminoethyl acrylate, aminoethyl methacrylate, methylaminoethyl methacrylate, dimethylaminoethyl methacrylate, ethylaminoethyl methacrylate, ethylmethylaminoethyl methacrylate, diethylaminoethyl methacrylate, aminopropyl acrylate, methylaminopropyl acrylate, dimethylaminopropyl acrylate, ethylaminopropyl acrylate, ethylmethylaminopropyl acrylate, diethylaminopropyl acrylate, aminopropyl methacrylate, methylaminopropyl methacrylate, dimethylaminopropyl methacrylate, ethylaminopropyl methacrylate, ethylmethylaminopropyl methacrylate, diethylaminopropyl methacrylate, dimethylaminoethylacrylamide, dimethylaminopropylacrylamide, and acryloyloxyethyltrimethylammonium salt. These materials may each have an intramolecular or intermolecular crosslink. These materials may be used either singly or as a copolymer or mixture of two or more of them. Besides, these materials may have a water-insoluble polymer added thereto as a reinforcing agent.

Now, the case where a gel which is composed of a combination of poly-N-isopropylacrylamide with polyacrylic acid or polymethacrylic acid and which contracts under a low-pH condition is used as the polymer gel 2 will be described below as an example.

[Swelling/Contraction Behaviors of Polymer Gel]

After power generation by the biofuel cell B is started, an oxidation-reduction reaction of a fuel proceeds at an enzyme immobilization film on the electrode 1, and the fuel in the fuel solution is consumed. Therefore, the fuel concentration of the fuel solution in the vicinity of the electrode 1 is lowered with the lapse of time. Attendant on this, the concentration of the fuel in the fuel solution 3 becomes lower in the vicinity of the electrode 1 than in the areas remote from the electrode 1, so that a fuel concentration gradient is generated in the fuel solution 3. Accordingly, the quantity of the fuel supplied to the electrode 1 by spontaneous diffusion is reduced, the oxidation-reduction reaction of the fuel at the enzyme immobilization film on the electrode 1 is suppressed, and the output of the biofuel cell B starts being lowered (see time T₁, in the drawing). Simultaneously, protons are produced as the oxidation-reduction reaction of the fuel proceeds at the enzyme immobilization film on the electrode 1, so that the proton concentration of the fuel solution 3 in the vicinity of the electrode 1 increases with the lapse of time. Attendant on this, the pH of the fuel solution 3 becomes lower in the vicinity of the electrode 1 than in the areas remote from the electrode 1, so that a pH gradient is generated in the fuel solution 3. Consequently, the pH in the vicinity of the electrode 1 is deviated from an optimum pH, which would cause a lowering in the efficiency of the oxidation-reduction reaction of the fuel at the enzyme immobilization film on the electrode 1.

On the other hand, when the proton concentration of the fuel solution 3 in the vicinity of the electrode 1 rises due to the progress of the oxidation-reduction reaction of the fuel at the enzyme immobilization film on the electrode 1, the proton concentration of the fuel solution 3 making contact with the polymer gel 2 also rises. In this instance, the polymer gel 2 contracts in response to the rise in the proton concentration of the fuel solution 3 (see time T₂). Specifically, protons are supplied to carboxyl groups (COO⁻) in the polymer gel 2, whereby electrical repulsion forces of the carboxyl groups are weakened, so that the polymer gel 2 contracts.

The contraction of the polymer gel 2 results in that the internal volume of each of the pores 11 is increased, as shown at the bottom of the drawing, whereby the diffusibility of the fuel solution 3 and of the protons in the solution from the inside of the pores 11 (see block arrows, in the drawing) is enhanced. In addition, the contraction of the polymer gel 2 leads to stirring of the fuel solution 3 in the pores 11. As a result of these processes, the fuel concentration gradient and the pH gradient generated in the fuel solution 3 are eliminated, and the oxidation-reduction reaction of the fuel at the enzyme immobilization film on the electrode 1 is increased, so that the output of the biofuel cell B having started to be lowered is recovered (see time T₃).

When the proton concentration of the fuel solution 3 in the vicinity of the electrode 1 is lowered due to the elimination of the pH gradient generated in the fuel solution 3, the proton concentration of the fuel solution 3 making contact with the polymer gel 2 is lowered, too. In this case, the polymer gel 2 swells in response to the lowering in proton concentration (rise in pH) of the fuel solution 3 (see time T₄). Specifically, protons are electrolytically dissociated from the carboxyl groups (COOH) in the polymer gel 2, whereby electrical repulsion forces of the carboxyl groups are increased, so that the polymer gel 2 swells. The swelling of the polymer gel 2, also, shows a stirring effect on the fuel solution 3.

When the fuel concentration gradient and the pH gradient in the vicinity of the electrode 1 are dispelled and the oxidation-reduction reaction of the fuel at the enzyme immobilization film on the electrode 1 is augmented, power generation at a high output is continued until a fuel concentration gradient and a pH gradient are again generated in the fuel solution 3. Thereafter, when a fuel concentration gradient and a pH gradient are generated in the fuel solution 3 attendantly on the progress of the oxidation-reduction reaction and the cell output starts being lowered, contraction of the polymer gel 2 occurs and the cell output is recovered by the above-described mechanism.

As above-mentioned, in the biofuel cell B, when the efficiency of the oxidation-reduction reaction of the fuel on the electrode 1 is lowered and the cell output starts being lowered due to the generation of the fuel concentration gradient and the pH gradient in the fuel solution 3 attendant on the progress of the oxidation-reduction reaction of the fuel, the polymer gel 2 contracts so as to enhance the diffusibility of proton of the fuel solution 3 and of the fuel in the solution and to eliminate the deviations of fuel concentration and pH in the vicinity of the electrode 1, thereby automatically restoring the cell output. In the biofuel cell B, therefore, the problem of a lowering in output experienced in the passive-type biofuel cells according to the related art can be solved, and a high cell output can be maintained.

In this embodiment, the case where an ion-responsive gel which swells and contracts in response to proton ion concentration of a fuel solution, speicifically, a proton-responsive gel which swells in a high-pH condition and contracts in a low-pH condition is used as the polymer gel 2 has been described as an example. However, the polymer gel 2 to be used may be an ion-responsive gel which contracts in a high-pH condition and swells in a low-pH condition, contrary to the above. In this case, also, the polymer gel 2 repeats swelling and contraction in response to variations in the proton concentration in the vicinity of the electrode 1, whereby stirring of the fuel solution 3 can be achieved. Consequently, the fuel concentration gradient and the pH gradient generated in the fuel solution 3 attendant on the progress of the oxidation-reduction reaction can be dispelled, and the deviations of fuel concentration and pH in the vicinity of the electrode 1 can be eliminated, so that the cell output can be recovered.

In addition, the polymer gel 2 is not limited to the ion-responsive gel which swells and contracts in response to proton ion concentration, but may be any of ion-responsive gels which swell and contract in response to concentrations of various ions generated, or varied in concentration thereof, attendant on the progress of the oxidation-reduction reaction of a fuel.

### 3. Third Embodiment

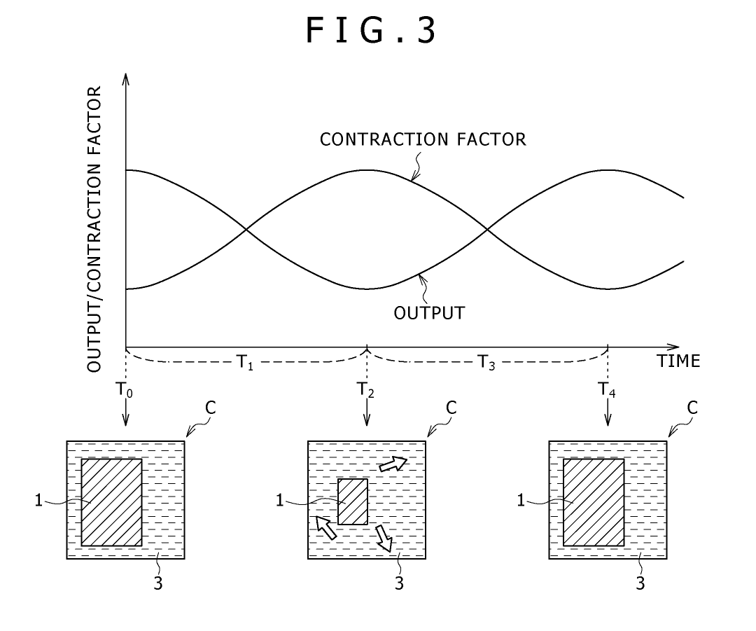

FIG. 3 illustrates the configuration of a biofuel cell according to a third embodiment of the present invention and swelling/contraction behaviors of a polymer gel disposed in the biofuel cell. At the top of the drawing is a graph showing time variations in output of the biofuel cell and in contraction factor of the polymer gel. At the bottom of the drawing are schematic illustrations showing the configuration of the vicinity of an electrode in the biofuel cell and the swelling/contraction behaviors of the polymer gel.

The biofuel cell denoted by symbol C in the figure includes an electrode 1 having a laminate structure, a polymer gel (not shown in the drawing) disposed in the inside (in gaps of the laminate) of the electrode 1, and a fuel solution 3 for supplying the electrode 1 with a fuel.

[Fuel Solution, Current Collectors, Protonic Conductor, and Enzymes]

The fuel solution 3, current collectors, a protonic conductor, enzymes and the like in the biofuel cell C may be the same in configuration as those in the biofuel cell A described in the first embodiment above.

[Electrodes]

The electrode 1 is formed from a porous material which can be electrically connected to an external member, like in the biofuel cell B described above; particularly, the electrode 1 is formed from a laminate of carbon fibers, carbon particulates, carbon felt, or carbon paper. The electrode formed from such a material has flexibility such as to be easily deformable under external forces. In the biofuel cell C, the polymer gel (not shown) is present in gaps between layers of the laminate of carbon fibers or the like constituting the electrode 1. Specifically, when the electrode 1 is the laminate of carbon fiber, the polymer gel 2 exists in gaps of the carbon fibers.

[Polymer Gel]

The polymer gel reversibly swells and contracts in response to variations in a property of the fuel solution making contact therewith. In the present embodiment, the case where a temperature-responsive gel which swells and contracts in response to the temperature of the fuel solution, specifically, a temperature-responsive gel which contacts under a high-temperature condition and swells under a low-temperature condition is used will be described as an example.

The polymer gel is obtained by crosslinking a polymer compound which in a solution is in a uniformly dissolved state equal to or below a certain temperature but, equal to or above the certain temperature, undergoes phase separation into two phases different in composition. The polymer gel swells equal to or below a phase transition temperature and contracts by releasing a medium equal to or above the phase transition temperature.

As such a polymer gel, there can be used, for example, a biodegradable temperature-responsive polymer of a block polymer type composed of polylactic acid and polyethylene glycol, and a vinyl monomer type polymer such as poly(N-isopropylacrylamide), poly(methyl vinyl ether), etc.

[Swelling/Contraction Behaviors of Oolymer Gel]

After power generation by the biofuel cell C is started, an oxidation-reduction reaction of a fuel proceeds at an enzyme immobilization film on the electrode 1, and the fuel in the fuel solution is consumed. Therefore, the fuel concentration of the fuel solution 3 in the vicinity of the electrode 1 is lowered with the lapse of time. Attendant on this, the concentration of the fuel in the fuel solution 3 becomes lower in the vicinity of the electrode 1 than in the areas remote from the electrode 1, so that a gradient of fuel concentration is generated in the fuel solution 3. Accordingly, the quantity of the fuel supplied to the electrode 1 by spontaneous diffusion is reduced, and the oxidation-reduction reaction of the fuel at the enzyme immobilization film on the electrode 1 is suppressed, so that the output of the biofuel cell C starts to be lowered (see time T₁, in the drawing). Simultaneously, the progress of the oxidation-reduction reaction of the fuel at the enzyme immobilization film on the electrode 1 causes generation of heat of reaction, thereby raising the temperature of the fuel solution 3 in the vicinity of the electrode 1. Accordingly, the temperature in the vicinity of the electrode 1 is deviated from an optimum temperature, causing a lowering in the efficiency of the oxidation-reduction reaction of the fuel at the enzyme immobilization film on the electrode 1.

On the other hand, when the temperature in the vicinity of the electrode 1 rises due to the progress of the oxidation-reduction reaction of fuel at the enzyme immobilization film on the electrode 1, the temperature of the fuel solution 3 making contact with the polymer gel present in the gaps in the laminate constituting the electrode 1 rises, too. In this instance, the polymer gel contacts in response to the rise in the temperature of the fuel solution 3 (see time T₂).

When the polymer gel present in the gaps in the laminate contracts, as shown at the bottom of the drawing, the electrode 1 as a whole contracts, whereby the volume for containing the fuel solution 3 is increased, and the diffusibility of the fuel solution 3 (see block arrows, in the drawing) is enhanced. In addition, the contraction of the electrode 1 as a whole leads to stirring of the fuel solution 3. As a result of these processes, the fuel concentration gradient and the temperature rise in the vicinity of the electrode 1 are dispelled, and the oxidation-reduction reaction of the fuel at the enzyme immobilization film on the electrode 1 is augmented, whereby the output of the biofuel cell C having started to be lowered is recovered (see time T₃).

When the temperature rise in the vicinity of the electrode 1 is eliminated, the temperature of the fuel solution 3 making contact with the polymer gel is also lowered. In this instance, the polymer gel swells in response to the lowering in the temperature of the fuel solution 3 (see time T₄). This swelling of the polymer gel also exhibits a stirring effect on the fuel solution 3.

When the fuel concentration gradient and the temperature rise in the vicinity of the electrode 1 are dispelled and the oxidation-reduction reaction of the fuel at the enzyme immobilization film on the electrode 1 is thus augmented, power generation at a high output is continued until a fuel concentration gradient and a temperature rise are again generated. Thereafter, when a fuel concentration gradient and a temperature rise are generated in the vicinity of the electrode 1 attendant on the progress of the oxidation-reduction reaction and the cell output starts being thus lowered, contraction of the polymer gel takes place, and the cell output is recovered through the above-described mechanism.

As above-mentioned, in the biofuel cell C, when the efficiency of the oxidation-reduction reaction of the fuel on the electrode 1 is lowered and the cell output starts being lowered due to the generation of the fuel concentration gradient and the temperature rise in the vicinity of the electrode 1 attendant on the progress of the oxidation-reduction reaction of the fuel, the polymer gel contracts so as to enhance the diffusibility of the fuel solution 3 and to eliminate the fuel concentration gradient and the temperature rise, thereby automatically recovering the cell output. In the biofuel cell C, therefore, the problem of a lowering in output experienced in the passive-type biofuel cells according to the related art can be solved, and a high cell output can be maintained.

In this embodiment, the case where a temperature-responsive gel which swells and contracts in response to temperature of a fuel solution, specifically, a temperature-responsive gel which contracts in a high-temperature condition and swells in a low-temperature condition is used as the polymer gel has been described as an example. However, the polymer gel to be used may be a temperature-responsive gel which swells in a high-temperature condition and contracts in a low-temperature condition, contrary to the above. In this case, also, the polymer gel repeats swelling and contraction in response to variations in the temperature in the vicinity of the electrode 1, whereby stirring of the fuel solution 3 can be achieved. Consequently, the fuel concentration gradient and the temperature rise generated in the vicinity of the electrode 1 attendant on the progress of the oxidation-reduction reaction can be dispelled, and the cell output can be restored.

In the biofuel cells according to the embodiments of the present invention, the fuel concentration gradient or the pH gradient in the fuel solution or the temperature variation in the vicinity of the electrode which is generated attendant on the progress of the oxidation-reduction reaction of the fuel is detected by the polymer gel and the polymer gel repeats swelling and contraction in a reversible manner, whereby the cell output lowered due to the fuel concentration gradient or the like can be automatically recovered. Therefore, the biofuel cell according to an embodiment of the present invention can take out more electric power from the same amount of fuel, can maintain a higher output, can enhance the final fuel utilization efficiency and can be used for a longer time, as compared with the biofuel cells according to the related art.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2010-089554 filed in the Japan Patent Office on Apr. 8, 2010, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A biofuel cell comprising a polymer gel reversibly swelling and contracting in response to variations in a property of a fuel solution making contact therewith, the polymer gel being on a surface of an electrode and/or in the inside of the electrode.

2. The biofuel cell according to claim 1, wherein the electrode has a porous material, and the polymer gel is present in pores of the electrode.

3. The biofuel cell according to claim 2, wherein the electrode has a laminate of carbon fibers, and the polymer gel is present in gaps between the carbon fibers.

4. The biofuel cell according to claim 1,
wherein the variations in the property are variations in at least one selected from the group consisting of fuel concentration, ion concentration and temperature of the fuel solution; and
the polymer gel is at least one selected from the group consisting of a molecule-responsive gel, an ion-responsive gel, and a temperature-responsive gel.

5. The biofuel cell according to claim 4, wherein the polymer gel is at least one selected from the group consisting of a molecule-responsive gel which swells in the presence of a fuel and contracts in the absence of the fuel, a proton-responsive gel which swells under a high-pH condition and contracts under a low-pH condition, and a temperature-responsive gel which contracts under a high-temperature condition and swells under a low-temperature condition.

6. The biofuel cell according to claim 4, wherein the polymer gel is at least one selected from the group consisting of a molecule-responsive gel which contracts in the presence of a fuel and swells in the absence of the fuel, a proton-responsive gel which contracts under a high-pH condition and swells under a low-pH condition, and a temperature-responsive gel which swells under a high-temperature condition and contracts under a low-temperature condition.
